(19) United States
(12) Patent Application Publication
(10) Pub. No.: US 2018/0263256 A1
(43) Pub. Date: Sep. 20, 2018

(54) MACHINE FOR THE PRODUCTION OF ICE-CREAM AND HEAT EXCHANGE DEVICE USED IN SAID MACHINE

(71) Applicant: DE' LONGHI APPLIANCES S.R.L. CON UNICO SOCIO, Treviso (IT)

(72) Inventors: Giuseppe De' Longhi, Treviso (IT); Andrea Moro, Treviso (IT)

(73) Assignee: DE' LONGHI APPLIANCES S.R.L. CON UNICO SOCIO, Treviso (IT)

(21) Appl. No.: 15/534,981

(22) PCT Filed: Dec. 9, 2015
(86) PCT No.: PCT/IB2015/059474

§ 371 Date: Jun. 9, 2017

(30) Foreign Application Priority Data
Dec. 9, 2014 (IT) UD2014A000186

(51) Int. Cl. A23G 9/12; A23G 9/22

(52) U.S. Cl. CPC A23G 9/12; A23G 9/22

(57) ABSTRACT

Machine for the production of ice cream, provided with a support body inside which a container for ingredients can be removably inserted, and a cooling circuit comprising an evaporator. The evaporator consists of at least one or more coils and a support casing defining an internal surface and an external surface on which the one or more coils adhere. At least the peripheral surface of the coils facing the external surface of the container is compressed.

### FIELD OF THE INVENTION

The present invention concerns a machine for the production of ice-cream of the type used in the domestic and/or professional field.

The invention also concerns a heat exchange device suitable to be used in the machine and configured so as to increase the heat exchange characteristics during the production of the ice-cream.

### BACKGROUND OF THE INVENTION

Substantially automatic machines to produce ice-cream are known, in the domestic and/or professional field.

These machines generally comprise a container for the ingredients to prepare the ice-cream, which is normally holed axially and inserted inside a support body.

The support body normally contains inside it a motorized drive mechanism to drive a blade to mix the ingredients, and also at least part of the cooling circuit by means of which the ingredients are taken to the temperature suitable to form the ice-cream.

To produce ice-cream it is known to put the container inside the support body.

A preparation and/or the ingredients needed to produce ice-cream are put inside the container, as well as a liquid, for example water, milk or other.

Once inserted, the ingredients start to cool and are mixed and homogenized by the mixing blade.

The support body can also comprise a timing mechanism to set and/or pre-memorize the mixing times needed to obtain the ice-cream according to the methods required by the type of preparation.

The mixing of the preparation and the liquid, and the low temperature induced by the cooled walls, promote the formation of the ice-cream until it is ready for consumption.

The cooling circuit normally comprises at least an evaporator device that surrounds the walls of the container of the ingredients for the production of ice-cream from the outside, determining a heat transmission by means of which the temperature of the ingredients is lowered to the desired value.

If applied in the domestic field, the evaporator must develop a high cooling capacity, given the limited size of the components.

In this context evaporators of the coil type are known, inside which a heat exchange fluid flows, for example glycol, or a gel. These known coil-type evaporators define a substantially cylindrical cavity inside which the container is located, with the ingredients of the ice-cream to be produced.

In known evaporators, between the coils and the support casing, due to the generally circular shape of the coil, there is usually a discontinuous contact, due to which empty spaces are formed, between one point of contact between the coil and the wall and the adjacent one, which can create considerable heat dispersion.

Examples of machines for the production of ice-cream are described, by way of example, in documents U.S. Pat. No. 3,952,538 and GB 2 150 683.

Document U.S. Pat. No. 3,952,538 describes a machine for the production of ice-cream having a cavity with a truncated cone shaped heat conductive wall inside which a truncated cone shaped container can be housed. A cooling device cooperates with the heat conductive wall substantially over its whole extension.

Document GB 2 150 683 describes a machine for the production of ice-cream having a cylindrical cavity to house a cylindrical container. The machine comprises an evaporator that surrounds the container with compressed coils, in particular flattened, to increase the heat exchange surface with the container. It must also be noted that, in order to optimize the heat exchange properties, such evaporators are generally made of aluminum or similar materials, and this causes problems in particular in the welding of several coils and/or in the production step.

Another disadvantage of known coil-type evaporators is that only containers with a diameter mating with the diameter of the cylindrical cavity can be introduced inside them. This is particularly disadvantageous if, for example, it is necessary to produce quantities of ice-cream different from the capacities of the containers available.

Due to these problems there is therefore a need to optimize as much as possible the efficiency of the heat exchange between the evaporator and the container, in particular for machines to produce ice-cream of the domestic type.

One purpose of the present invention is to obtain a machine for the production of ice-cream that can improve the efficiency of the heat exchange between evaporator and container.

Another purpose is to obtain an evaporator device for machines for the production of ice-cream that can improve the efficiency of the heat exchange.

Another purpose of the present invention is to obtain a machine for the production of ice-cream that can produce quantities of ice-cream that vary according to the needs and requirements of a user and/or consumer and that therefore allows to use containers with different capacities and sizes.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, a machine for the production of ice-cream is provided, in a substantially conventional manner, with a support body inside which a container for ingredients can be removably inserted, and a cooling circuit comprising at least an evaporator element.

The container comprises a lateral wall and a containing compartment for the ingredients that make up the ice-cream.

The evaporator element consists of a plurality of coils which, during use, are tightly wound one on the other and contact the external surface of the container, either directly or by means of a support casing, in order to achieve the heat exchange that determines the cooling of the ingredients inserted inside the container.

According to one characteristic of the present invention, at least the peripheral surface of the coils facing the external surface of the container is compressed, defining a D-shaped section, so as to define a substantially flat contact surface, with respect to the point-by-point contact that occurs when the coils have a substantially circular section.

The D shape, together with the close proximity of adjacent coils, causes a substantial linear support continuity of the surfaces of the coils with the mating external surface of the container, promoting an effective and uniform heat exchange.

Furthermore, in the case of a compressed section, the contact surfaces of adjacent coils are nearer each other and the empty spaces between adjacent coils, where there is substantially no heat exchange, are reduced.

Moreover, in another formulation of the invention, inside the empty spaces defined between the external surface of the support or cooling casing, and the one or more coils, a filler material can be interposed, which can have high thermal conductivity.

According to another characteristic of the present invention, the coils of the evaporator element are made of copper and, at least at their ends, have an internal core made of weldable material which protrudes from the external covering made of copper to allow welding of two or more adjacent coils to each other and/or to the pipes that feed the cooling liquid.

According to another characteristic of the present invention, the plurality of coils, together with the corresponding support casing, define a housing seating for the container, with a conical shape section, and said container has a mating conical shape.

Thanks to the conical configuration of the cavity defined by the coils and the support casing on the external face of which the coils are applied, for example welded, it is possible to insert inside it containers with a different size, in order to satisfy specific requirements in terms of quantity of ice-cream to be produced.

The mating conical conformation of the cavity defined by the coils and the container of the ingredients also allows an intimate contact, whatever the size of the container, between the external surface of the container and the coils of the evaporator element, promoting a better heat exchange and a more effective cooling of the ingredients.

In the machine for the production of ice-cream according to the invention, the one or more coils of the evaporator element define a plurality of contact portions, direct or indirect, with the external surface of the support casing and can be compressed against said external surface.

### BRIEF DESCRIPTION OF THE DRAWINGS

These and other characteristics of the present invention will become apparent from the following description of some forms of embodiment, given as a non-restrictive example with reference to the attached drawings wherein:

FIG. 1 is a front section view of a machine for the production of ice-cream according to the present invention;

FIG. 2 is a section view of the evaporator in FIG. 4, with a container according to the present invention inserted inside it;

FIG. 3 is an enlarged detail of the evaporator in FIG. 2, according to the present invention;

FIG. 4 is a lateral view of a coil of the evaporator element of the machine in FIG. 1, according to the present invention.

To facilitate comprehension, the same reference numbers have been used, where possible, to identify identical common elements in the drawings. It is understood that elements and characteristics of one form of embodiment can conveniently be incorporated into other forms of embodiment without further clarifications.

### DETAILED DESCRIPTION OF SOME FORMS OF EMBODIMENT

We shall now refer in detail to the various forms of embodiment of the present invention, of which one or more examples are shown in the attached drawings. Each example is supplied by way of illustration of the invention and shall not be understood as a limitation thereof. For example, the characteristics shown or described insomuch as they are part of one form of embodiment can be adopted on, or in association with, other forms of embodiment. It is understood that the present invention shall include all such modifications and variants.

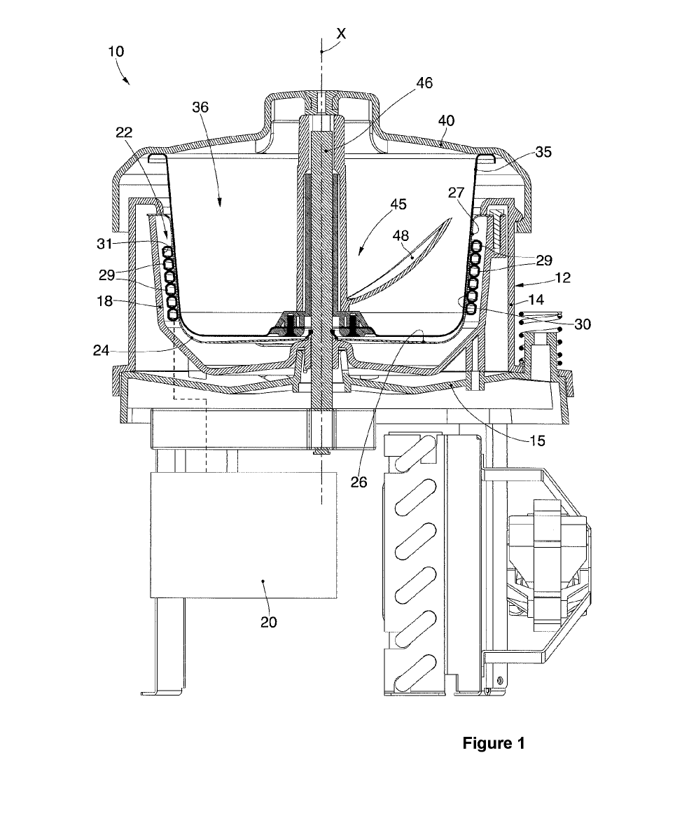

According to the present invention, a machine 10 for the production of ice-cream, partly shown in FIG. 1, can comprise a support body 12, hollow inside, to contain the ice-cream during its preparation.

The support body 12 can for example have a box-like shape, cylindrical or conical, and can be made of heat-insulating material.

The support body 12 is provided with an external wall 14 which can substantially delimit its lateral bulk, and with a bottom wall 15 located below the machine 10 in order to support it.

According to some forms of embodiment, the support body 12 can be provided with an insulating casing 18 inserted inside it.

The insulating casing 18 can have a cylindrical or conical shape, and is hollow inside.

The machine 10 is provided with a cooling circuit 20 to cool the ice-cream inside the support body 12.

The cooling circuit 20 can be, for example, a heat pump that exploits in a known manner the heat exchanges deriving from the phase changes that take place inside it.

The cooling circuit 20 is a substantially known type and its configuration and structure are not relevant here for the present invention, except for the features that will be described in detail hereafter.

The cooling circuit 20 can comprise a condenser, a compressor, an electronic expansion valve, not shown in the drawings, and an evaporator 22.

As shown in FIGS. 3-4, the evaporator 22 can consist of one or more coils 29 that define a support or cooling casing 24.

The support casing 24 can be smaller than the insulating casing 18 and is disposed substantially inside and resting on the latter.

According to the present invention, the support casing 24, onto the external face of which the coils 29 of the evaporator element 22 are welded, has a conical shape, for the reasons described in more detail hereafter.

The support casing 24 can be hollow inside and can define an internal surface 26 and an external surface 27.

According to the present invention, the coils 29 of the evaporator element 22 extend, closely adjacent to each other, substantially along the whole external surface 27 of the support casing 24.

In particular, the coils 29 surround the entire support casing 24 in a lower portion thereof.

According to one form of embodiment of the present invention, the coils 29 and the support casing 24 are made of copper.

The use of this material advantageously allows to facilitate the operations to attach the coils 29 on the external surface 27 of the support casing 24.

The coils 29 can be disposed adhering, with several contact portions 30, to the external surface 27 of the support casing 24.

According to the present invention, the coils 29 can be provided, longitudinally to their development, with an interspace 31 inside which a suitable cooling liquid or gel can flow, able to be frozen and/or unfrozen according to the functioning of the cooling circuit 20.

Inside the evaporator 22 a container 35 can be removably inserted, having a containing seating 36 to contain, mix and cool the ingredients of the ice-cream.

According to the present invention, the container 35 advantageously has a conical shape, substantially mating with that of the housing seating defined by the conical section of the coils 29, and/or the support casing 24, to be disposed during use, resting on the internal surface 26 of the evaporator 22.

Thanks to the conical shape of the housing seating defined by the support casing 24, and hence by the coils 29, the container 35 can be variable in size, and hence not constrained to a specific size, and can be housed stably in the housing seating defined by the evaporator 22.

In particular, the invention advantageously allows to use containers 35 having different capacities to produce varying quantities of ice-cream depending on the requirements and needs of a user and/or consumer.

The evaporator 22, in particular its internal surface 26, is disposed in contact with the external wall of the container 35 in order to cool it after the cooling of the cooling liquid contained inside the interspace 31 of the coils 29.

According to one form of embodiment of the present invention, the coil 29 has a compressed section shape, for example D-shaped, at least on the face facing toward the external surface 27 of the support casing 24, and hence toward the container 35.

This section shape allows to increase the overall surface of the contact portions 30 of the coils 29 on the external surface 27 of the support casing 24 and consequently to reduce the empty spaces that are created through a discontinuity of contact with the latter. In this way the heat dispersion of the heat transmitted by the evaporator 22 is reduced, and the heat exchange efficiency is advantageously increased.

According to another form of embodiment of the present invention, a filler material M can be provided, preferably with high thermal conductivity, interposed between the coils 29 and the external surface 27 of the support casing 24 inside the empty spaces.

Providing the material M, it is possible to considerably increase the heat exchange efficiency between evaporator 22 and container 35, substantially zeroing the empty spaces and creating a substantially continuous contact between external surface 27 and coils 29.

According to another form of embodiment of the present invention, the internal surface 26 can be smooth. By smooth surface we mean a surface that has a linear development without interruptions of material.

This characteristic advantageously allows to further increase the heat exchange efficiency between evaporator 22 and container 35 as described above.

Between the insulating casing 18 and the external 14 and bottom 15 walls, and between the evaporator 22 and the external wall 14, empty spaces are created which allow to insulate the container 35 thermally with respect to the outside.

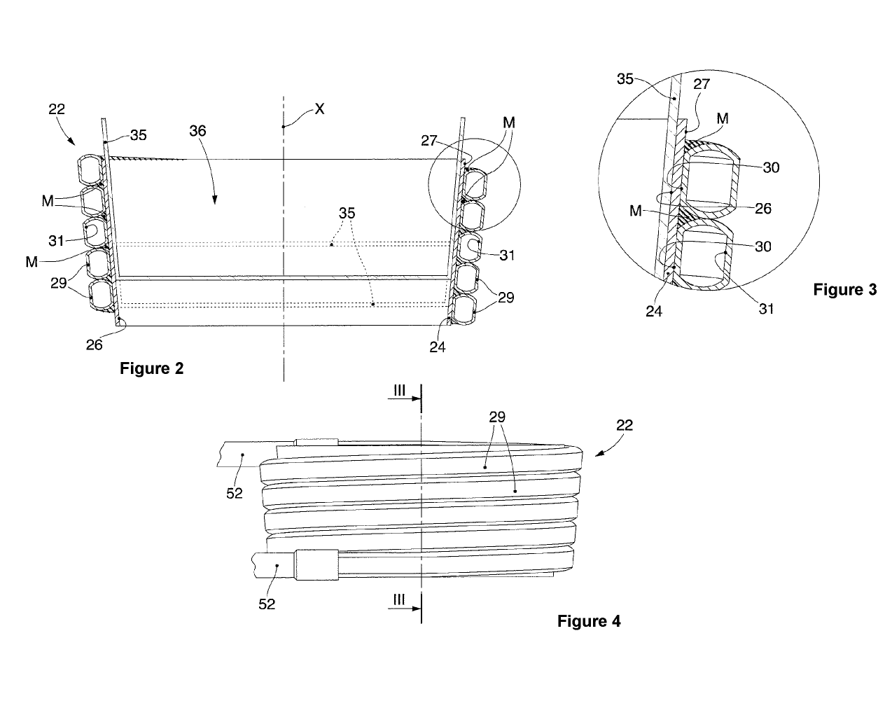

As shown in FIG. 2, at least the ends of the coils 29 can be provided with internal terminal cores 52 made of easily weldable material to facilitate the welding operations between consecutive coils and/or between coil and cooling liquid feed pipes.

According to the present invention, the machine 10 can be provided with a removable lid 40, which can be disposed resting on the support body 12 to seal the containing seating 36 from the outside.

According to the present invention, the machine 10 can be provided with a mixing unit 45 to mix the ingredients contained inside the container 35 during the preparation of the ice-cream, in particular during cooling.

The mixing unit 45 can be provided with a shaft 46 rotating around a longitudinal axis X, passing through the center of the machine 10 described here and through a cavity provided axially in the container 35.

A mixing blade 48 can be mounted on the shaft 46, and can perform the mixing of the ingredients as described above.

According to the present invention, the shaft 46 can support and substantially hinge the whole support body 12.

According to some forms of embodiment of the present invention, the machine 10 can be provided with a defrosting system for the evaporator.

The defrosting system can provide, for example, electromagnetic sensors to detect the presence of ice inside the evaporator 22.

In this example form of embodiment, once ice has been detected, the defrosting system can command electric resistances to defrost the evaporator 22.

In other forms of embodiment, the defrosting system provides an electrochemical treatment inside the coils 29 of the evaporator 22.

In other forms of embodiment, the evaporator 22 can be defrosted exploiting the inverse principle of a heat pump, i.e. inverting the functioning of the cooling circuit 20.

It is clear that modifications and/or additions of parts may be made to the machine as described heretofore, without departing from the field and scope of the present invention.

It is also clear that, although the present invention has been described with reference to some specific examples, a person of skill in the art shall certainly be able to achieve many other equivalent forms of machines, having the characteristics as set forth in the claims and hence all coming within the field of protection defined thereby.

1. Machine for the production of ice cream, provided with a support body inside which a container for ingredients can be removably inserted, and a cooling circuit comprising an evaporator, wherein said evaporator consists of at least one or more coils made of copper, and a support casing, also made of copper, defining an internal surface and an external surface on which said one or more coils adhere, wherein at least the peripheral surface of the coils facing the external surface of the container is compressed, in that said coils of the evaporator element extend, closely adjacent to each other, along the whole external surface of the support casing, and in that a filler material is interposed inside hollow spaces defined between said external surface of said support casing and said one or more coils.

2. Machine as in claim 1, wherein the section of said coils is D-shaped, so as to define a substantially flat contact surface facing toward the external surface of the container.

3. Machine as in claim 1, wherein said filler material is a material with high thermal conductivity.

4. Machine as in claim 1, wherein said support body is provided with an insulating casing on which the support casing rests.

5. Machine as in claim 1, wherein said support casing defines a housing seating for said container with a conical shape and in that said container has a mating shape with conical shape.

6. Machine as in claim 1, wherein, at least at their ends, said coils have internal end portions partly protruding and made of a weldable material.

7. Heat exchange device comprising an evaporator, wherein said evaporator consists of at least one or more coils and a support casing defining an internal surface and an external surface on which said one or more coils adhere, wherein at least one peripheral surface of the coils is compressed, and is D-shaped so as to define a substantially flat external surface, in that said coils of the evaporator element extend, closely adjacent to each other, along the whole external surface of the support casing, and in that a filler material is interposed inside hollow spaces defined between said external surface of said support casing and said one or more coils.

8. Heat exchange device as in claim 7, wherein said support casing defines a housing seating with a conical shape.
